(19) United States
(12) Patent Application Publication
(10) Pub. No.: US 2026/0271035 A1
(43) Pub. Date: Sep. 10, 2026

(54) COMMUNICATION CONTROL METHOD AND APPARATUS

(71) Applicant: BEIJING XIAOMI MOBILE SOFTWARE CO., LTD., Beijing (CN)

(72) Inventor: Xuemei QIAO, Beijing (CN)

(21) Appl. No.: 19/469,706

(22) PCT Filed: Mar. 31, 2023
(86) PCT No.: PCT/CN2023/085800

§ 371 Date: Sep. 26, 2025

(51) Int. Cl. H04W 72/30; H04L 5/00; H04W 72/0453; H04W 72/0457; H04W 72/51

(52) U.S. Cl. CPC H04W 72/30; H04L 5/0044; H04W 72/0453; H04W 72/0457; H04W 72/51

(57) ABSTRACT

A communication control method comprises: sending a configuration signaling to a user equipment (UE), wherein the configuration signaling indicates a transmission parameter, and the transmission parameter is a parameter corresponding to at least one of a multicast traffic channel (MTCH) transmission or a multicast control channel (MCCH) transmission.

### CROSS-REFERENCE TO RELATED APPLICATION

The present application is a U.S. national phase of International Application No. PCT/CN 2023/085800, filed on Mar. 31, 2023, the content of which is incorporated herein by reference in its entirety.

### FIELD

The disclosure relates to the field of communication technologies, and in particular relates to a communication control method and a communication control apparatus.

### BACKGROUND

A network device and a terminal may communicate via a multicast traffic channel (MTCH), for example, performing a broadcast transmission by transmitting a broadcast message of a multimedia broadcast service (MBS).

### SUMMARY

According to a first aspect of embodiments, there is provided a communication control method, performed by a network device, including: sending a configuration signaling to a user equipment (UE), in which the configuration signaling indicates a transmission parameter, and the transmission parameter is a parameter corresponding to an MTCH transmission and/or a multicast control channel (MCCH) transmission.

According to a second aspect of embodiments, there is provided a communication control method, performed by a UE, including: determining a transmission parameter according to a configuration signaling of a network device, in which the transmission parameter is a parameter corresponding to an MTCH transmission and/or an MCCH transmission.

According to a third aspect of embodiments, there is provided a communication apparatus, including: a transceiver; a memory; and a processor connected to the transceiver and the memory respectively, configured to control the transceiver to transmit and receive a wireless signal by executing computer-executable instructions on the memory, and to perform the method in the first aspect of embodiments or the second aspect of embodiments by executing computer executable instructions on the memory.

According to a fourth aspect of embodiments, there is provided a non-transitory computer storage medium having stored therein computer-executable instructions that, when executed by a processor, cause the method in the first aspect of embodiments or the second aspect of embodiments to be implemented.

### BRIEF DESCRIPTION OF THE DRAWINGS

In order to more clearly illustrate embodiments or the technical solutions in the background, the following is a description of the drawings to be used in the embodiments of the present disclosure or the background art.

FIG. 1 is a schematic architectural diagram illustrating a communication system according to an embodiment.

FIG. 2 is a schematic flow chart illustrating a communication control method according to an embodiment.

FIG. 3 is a schematic flow chart illustrating a communication control method according to an embodiment.

FIG. 4 is a schematic flow chart illustrating a communication control method according to an embodiment.

FIG. 5 is a schematic flow chart illustrating a communication control method according to an embodiment.

FIG. 6 is a schematic flow chart illustrating a communication control method according to an embodiment.

FIG. 7 is a schematic flow chart illustrating a communication control method according to an embodiment.

FIG. 8 is an interactive schematic diagram illustrating a communication control method according to an embodiment.

FIG. 9 is a schematic block diagram illustrating a communication control apparatus according to an embodiment.

FIG. 10 is a schematic block diagram illustrating a communication control apparatus according to an embodiment.

FIG. 11 is a schematic block diagram illustrating a communication apparatus according to an embodiment.

FIG. 12 is a schematic block diagram illustrating a chip according to an embodiment.

### DETAILED DESCRIPTION

Reference will now be made in detail to embodiments, examples of the embodiments are illustrated in the accompanying drawings. The following description refers to the accompanying drawings in which the same numbers in different accompanying drawings represent the same or similar elements unless otherwise represented. The implementations descripted in the following embodiments do not represent all implementations consistent with the disclosure. Instead, those implements are merely examples of apparatus and methods consistent with some aspects related to the disclosure as recited in the appended claims.

Terms used in embodiments are merely for the purpose of describing specific embodiments and are not be intended to limit embodiments. As used in the embodiments and the appended claims, “a/an” and “the” in singular forms are intended to include plural forms, unless clearly indicated in the context otherwise. The term “and/or” used herein represents and contains any or all possible combinations of one or more associated listed items.

Although terms such as “first,” “second” and “third” may be used in embodiments for describing various information, these information should not be limited by these terms. These terms are only used for distinguishing information of the same type from each other. For example, first information may also be referred to as second information, and similarly, the second information may also be referred to as the first information, without departing from the scope of embodiments. As used herein, the term “if” may be construed to mean “when” or “upon” or “in response to determining” depending on the context. For purposes of brevity and ease of understanding, when characterizing magnitude relationships herein, the terms used are “greater than” or “less than”, “higher than” or “lower than”. However, it may be understood to those skilled in the art that the term “greater than” also encompasses the meaning of “greater than or equal to”, the term “less than” also encompasses the meaning of “less than or equal to”; the term “higher than” encompasses the meaning of “higher than or equal to”, and the term “lower than” also encompasses the meaning of “lower than or equal to”.

For ease of understanding, terms to which the disclosure relates will first be introduced.

A quality of service (QoS) refers to a probability that a network satisfies a given service contract, or in many cases, informally refers to a probability that a packet passes between two points in a network. The QoS is a control mechanism, which provides different priorities for different users or different data flows, or ensures that the performance of data flows reaches a certain level according to requirements of an application program.

A positioning reference signal (PRS) is used to perform a positioning measurement, and positioning device may perform a positioning according to a measurement result.

In order to better understand a communication control method disclosed in embodiments, a communication system to which embodiments are applicable is first described below.

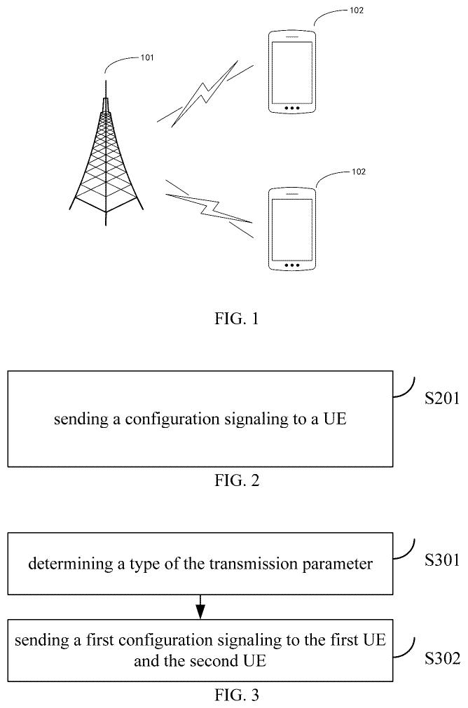

Referring to FIG. 1, FIG. 1 is a schematic architectural diagram illustrating a communication system according to an embodiment. The communication system may include, but is not limited to, a network device and a terminal. The number and form of devices shown in FIG. 1 are for example and do not constitute a limitation on embodiments. In practical applications, two or more network devices and two or more terminals may be included. The communication system shown in FIG. 1 is exemplified as including one network device 101 and one terminal 102.

It should be noted that the technical solutions of embodiments may be applied to various communication systems, for example: a long term evolution (LTE) system, a 5th generation (5G) mobile communication system, a 5G new radio (NR) system, or other future new mobile communication systems and the like. It should also be noted that a sidelink in embodiments may also be called a side link or a direct link.

The network device 101 in embodiments is an entity at a network side for transmitting or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (Wi-Fi) system and the like. The specific technology and specific device form adopted by the network device are not limited in the embodiments. The network device provided by embodiments may be composed of a central unit (CU) and a distributed unit (DU), in which the CU may also be referred to as a control unit. The CU-DU structure allows to split protocol layers of the network device, such as a base station. Functions of some protocol layers are centrally controlled in the CU, functions of some or all of the remaining protocol layers are distributed in the DU, and the CU centrally controls the DU.

The terminal 102 in embodiments is an entity at a user side for receiving or transmitting signals, such as a mobile phone. The terminal may also be referred to as a terminal device, a user equipment (UE), a mobile station (MS), a mobile terminal (MT), and the like. The terminal may be a vehicle with communication functions, a smart vehicle, a mobile phone, a wearable device, a Pad, a computer with wireless transceiving functions, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home and the like. The specific technology and specific device form used by the terminal are not limited in embodiments.

The communication system described in embodiments is for a purpose of more clearly illustrating the technical solution of embodiments, but does not constitute a limitation on the technical solutions provided by embodiments. Moreover, it is known by those skilled in the art that the technical solutions provided by embodiments are also applicable to similar technical problems with the evolution of the system architecture and the emergence of new business scenarios.

It should be noted that the communication control method provided by any embodiment may be performed alone, or may be performed in combination with possible implementation manners in other embodiments, or may be performed in combination with any technical solution in the related art.

In the existing research, a transmission bandwidth of a PDSCH channel on which an eRedcap UE carries a broadcast service has not been defined. A possible implementation is to specify a range of the transmission bandwidth for the eRedcap UE, such as limiting a number of RBs of an MTCH and an MCCH of the eRedcap UE to within 5 MHz. However, the method may affect the scheduling of the MTCH and the MCCH for a non-eRedcap UE. Therefore, it is necessary to consider separate scheduling for the two different types of terminals. However, due to the different number of allocated resources during the separate scheduling, excessive unnecessary downlink control information (DCI) blind detection and DCI reading may be introduced for the two different types of terminals. Therefore, the disclosure proposes that by configuring a transmission parameter, the network device may allocate reasonable frequency domain resources for the reception of a broadcast PDSCH of different terminals, thereby ensuring a transmission effectiveness and avoiding increasing an energy consumption of the terminal. Hereinafter, a communication control method and a communication control apparatus provided by the disclosure will be described in detail with reference to the accompanying drawings.

Referring to FIG. 2, FIG. 2 is a schematic flow chart illustrating a communication control method according to an embodiment. The method is performed by a network device. As shown in FIG. 2, the method may include but is not limited to a following step.

In step S201, a configuration signaling is sent to a UE.

In some embodiments, the UE includes a first UE and/or a second UE, the first UE may be an eRedcap UE, and the second UE may be a non-eRedcap UE. The first UE may include one or more eRedcap UEs, and the second UE may include one or more non-eRedcap UEs.

The eRedCap technology is an enhanced capability reduction technology proposed by 3rd generation partnership project (3GPP) in the 5G R18 stage, based on the RedCap technology proposed in the R17 stage. Therefore, the eRedCap terminal is also called an R18 RedCap terminal, which is intended to further reduce a complexity and cost of the terminal, and comprehensively improve 5G network quality and coverage. The non-eRedcap UE may be a traditional terminal, such as a legacy terminal.

In some optional implementations, the network device may configure a transmission parameter of a broadcast channel to the first UE and the second UE, in which the transmission parameter is a parameter corresponding to an MTCH transmission and/or an MCCH transmission.

In some embodiments, for the first UE, a number of PDSCH frequency domain RBs of the MTCH transmission is less than or equal to a first threshold, and/or a number of PDSCH frequency domain RBs of the MCCH transmission is less than or equal to the first threshold. That is, for the eRedcap UE, the number of PDSCH frequency domain RBs of the MTCH transmission is less than or equal to the first threshold, and/or the number of PDSCH frequency domain RBs of the MCCH transmission is less than or equal to the first threshold.

The first threshold may be different values according to different sub-carrier spacings (SCSs). For example, in a case where the SCS is 30 kHz, the number of RBs of a PDSCH of the terminal does not exceed 12 RBs, that is, the first threshold may be 12. In a case where the SCS is 15 KHZ, the number of RBs of the PDSCH of the terminal does not exceed 25 RBs, that is, the first threshold may be 25.

A number of first frequency domain RBs being less than or equal to 12 or being less than or equal to 25 may be understood as a corresponding transmission channel bandwidth being less than or equal to 5 MHz.

In some embodiments, for the first UE, there is no restriction on the number of PDSCH frequency domain RBs of the MTCH transmission and/or on the number of PDSCH frequency domain RBs of the MCCH transmission. That is, for the eRedcap UE, there is no restriction on the number of PDSCH frequency domain RBs of the MTCH transmission and/or on the number of PDSCH frequency domain RBs of the MCCH transmission.

In embodiments, the network device may adopt different configuration modes in a case of configuring the transmission parameter using the configuration signaling. That is, the network device may configure the transmission parameter for different types of terminals according to different modes. For example, the network device may configures, according to the configuration signaling, a shared transmission parameter for different types of terminals, or configures, according to the configuration signaling, separate transmission parameters for different types of terminals respectively, or configured the transmission parameter by other parameter configuration methods. The specific implementation method of parameter configuration is not limited by the embodiments of the present disclosure. Examples are given below.

a) The shared transmission parameter is configured for different types of terminals. For example, the network device may send a first configuration signaling to the first UE and the second UE, in which the first configuration signaling indicates a first transmission parameter, and the first UE and the second UE share the first transmission parameter. That is, in a case where the network device configures the transmission parameter, a same transmission parameter may be assigned to different types of terminals, and the different types of terminals share and use the same parameter. It should be noted that “sharing the same parameter” in the disclosure means that for a certain type or several types of transmission parameters, the first UE and the second UE share a same value of the transmission parameter. For example, for a transmission parameter CFR, both the first UE and the second UE share a CFR #1.

b) The separate transmission parameters are configured for different types of terminals, respectively.

For example, the network device may send a second configuration signaling to the first UE, and send a third configuration signaling to the second UE, in which the second configuration signaling indicates a second transmission parameter, the third configuration signaling indicates a third transmission parameter, and the second transmission parameter is different from the third transmission parameter. That is, the network device may configure different transmission parameters for different devices, and the different devices use different parameters separately. It should be noted that “using different parameters separately” in the disclosure means that for a certain type or several types of transmission parameters, the first UE and the second UE separately use different values of the transmission parameter. In other words, the transmission parameters configured for the first UE and the second UE are of the same type but have different values. For example, for the transmission parameter CFR, the network device configures a CFR #1 for the first UE and configures a CFR #2 for the second UE, and a value of the CFR #1 is different from a value of the CFR #2.

In some embodiments, in a case where different parameters are configured for different types of terminals, the network device also configures the transmission parameters correspondingly for different logical channels, such as the MTCH transmission and the MCCH transmission.

In embodiments, the network device may send the configuration signaling to the UE. Thus, by using the configured transmission parameter(s), the network device may allocate reasonable frequency domain resources for the broadcast transmission of different types of terminals, thereby ensuring the transmission effectiveness and improving the communication capability.

Referring to FIG. 3, FIG. 3 is a schematic flow chart illustrating a communication control method according to an embodiment. The method is performed by a network device. The embodiment shown in FIG. 3 is a further explanation of step S201 in the embodiments of FIG. 2. The method may include but is not limited to a following step.

In S301, a type of a transmission parameter is determined.

In some optional implementations, the network device may determine the type of the transmission parameter according to different modes. For example, the network device may determine a configuration mode according to a protocol agreement, that is, determine the type of the transmission parameter according to the protocol agreement. Alternatively, the network device may determine the configuration mode independently, that is, determine the type of the transmission parameter according to a transmission category, thereby configuring different values of the transmission parameter of this type to the first UE and the second UE. The specific determination method is not limited in embodiments.

Specifically, in a case where the network device configures the transmission parameter, the transmission parameter may include but is not limited to at least one of: an initial BWP; a CFR; a CORESET; a search space; an offset of an MCCH window; a period of an MCCH window; a G-RNTI; an MCCH-RNTI; or a DMRS resource.

In other words, in a case of configuring the transmission parameter, the network device may select a corresponding type of the transmission parameter via the protocol agreement or other setting modes, and configure different values of the transmission parameter of this type for the first UE and the second UE, thereby implement targeted broadcast transmission configuration for different types of terminals.

For example, the network device configures various types of transmission parameters to the first UE and the second UE, including the initial BWP, the CFR, the CORESET, the search space, the offset of the MCCH window, the period of the MCCH window, the G-RNTI, the MCCH-RNTI, and the DMRS resource, but for at least one of the above transmission parameters, the network device configures different values of the certain transmission parameter to the first UE and the second UE.

Taking the search space as an example, for the first UE, the network device configures a search space1 for the first UE and configures a search space2 for the second UE. For other transmission parameters, the network device may configure the same value or different values to the first UE and the second UE, which is not limited in the disclosure.

Specifically, for the MCCH, it may be distinguished by the MCCH-RNTI. For example, an MCCH-RNTI #1 is configured for the first UE, and an MCCH-RNTI #2 is configured for the second UE. Similarly, for the MTCH, it may be distinguished by the G-RNTI. For example, a G-RNTI #1 is configured for the first UE, and a G-RNTI #2 is configured for the second UE.

In some optional embodiments, for the MCCH transmission, the same value of the transmission parameter may be configured for the first UE and the second UE, while for the MTCH, separate and different values of the transmission parameter may be configured for the first UE and the second UE. In other words, different configuration rules may be used for the MCCH and the MTCH, and vice versa, which will not be repeated here.

In some optional embodiments, channels may not be distinguished, and a common configuration parameter value may be used for the two types of the terminal, which is not limited in the disclosure.

Step S301 is an optional step.

In step S302, a first configuration signaling is sent to the first UE and the second UE.

In this embodiment, the network device may send the first configuration signaling to the first UE and the second UE, in which the first configuration signaling indicates a first transmission parameter, and the first UE and the second UE share a value of the first transmission parameter. That is, in a case of configuring the transmission parameter, the network device may assign a same value of the transmission parameter to different types of terminals. The different types of terminals share and use the same value of the transmission parameter.

For example, the network device may send the first configuration signaling to the second UE to configure the first transmission parameter, such as configuring the initial BWP, the CFR, the CORESET or other parameters. Moreover, the first transmission parameters are also effective for the first UE.

In some embodiments, in a case of configuring a shared transmission parameter for the terminal, the network device may, for the MTCH transmission, send a fourth configuration signaling to the first UE, and send a fifth configuration signaling to the second UE, respectively. For the MCCH transmission, the network device may send a sixth configuration signaling to the first UE, and send a seventh configuration signaling to the second UE, respectively. The fourth configuration signaling indicates a fourth transmission parameter, the fifth configuration signaling indicates a fifth transmission parameter, the sixth configuration signaling indicates a sixth transmission parameter, the seventh configuration signaling indicates a seventh transmission parameter. Values of transmission parameters indicated by at least two of the fourth configuration signaling, the fifth configuration signaling, the sixth configuration signaling, and the seventh configuration signaling are different.

In other words, in a case where different types of terminals share and use the same parameter, the network device may also configure the transmission parameters according to different transmission modes, such as the MTCH transmission and the MCCH transmission. That is, different transmission parameter configurations may be performed for different transmission modes. For example, the MTCH transmission uses the transmission parameter(s) configured by the network device for the MTCH transmission, and the MCCH transmission uses the transmission parameter(s) configured by the network device for the MCCH transmission.

For example, the network device may send the fourth configuration signaling to the first UE in the MCCH transmission to configure the fourth transmission parameter, such as configuring the initial BWP, the CFR, or other parameters. The network device may send the fifth configuration signaling to the second UE in the MCCH transmission to configure the fifth transmission parameter, in which the fifth transmission parameter may be the same as the fourth transmission parameter. That is, different types of terminals share the same transmission parameter. Moreover, the network device may further send the sixth configuration signaling to the first UE in the MTCH transmission to configure the sixth transmission parameter, such as configuring the CORESET, the search space or other parameters. The network device may send the seventh configuration signaling to the second UE in the MTCH transmission to configure the seventh transmission parameter, in which the seventh transmission parameter may be the same as the sixth transmission parameter. That is, different types of terminals share the same transmission parameter.

In embodiments, the network device sends the configuration signaling to the first UE and the second UE to configure the shared transmission parameter, such that the network device allocates reasonable frequency domain resources for the broadcast transmission of different types of terminals, thereby ensuring the transmission effectiveness and avoiding reducing the energy consumption of the terminal.

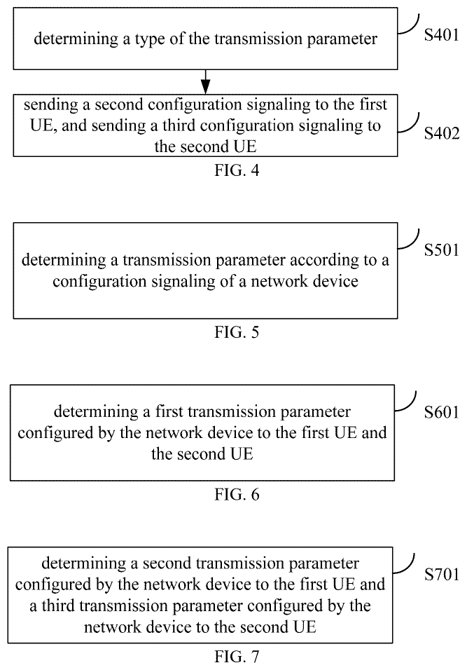

Referring to FIG. 4, FIG. 4 is a schematic flow chart illustrating a communication control method according to an embodiment. The method is performed by a network device. The embodiment shown in FIG. 4 is a further explanation of step S201 in the embodiments of FIG. 2. The method may include but is not limited to a following step.

In S401, a type of a transmission parameter is determined.

This step is an optional step. For specific descriptions, please refer to step S301, which will not be repeated here.

In step S402, a second configuration signaling is sent to a first UE, and a third configuration signaling is sent to a second UE.

In this embodiment, the network device may send the second configuration signaling to the first UE and send the third configuration signaling to the second UE, in which the second configuration signaling indicates a second transmission parameter, the third configuration signaling indicates a third transmission parameter, and the second transmission parameter is different from the third transmission parameter. That is, the network device may assign different transmission parameters to different devices, and different devices may use different parameters separately.

For example, the network device configures various types of transmission parameters to both of the first UE and the second UE, in which the various types of transmission parameters may include at least one of: an initial BWP, a CFR, a CORESET, a search space, an offset of an MCCH window, a period of an MCCH window, a G-RNTI, an MCCH-RNTI, or a DMRS resource. However, for at least one of the above transmission parameters, the network device configures different values to the first UE and the second UE.

Taking the search space as an example, for the first UE, the network device configures a search spacel for the first UE and configures a search space2 for the second UE. For other transmission parameters, the network device may configure the same value or different values to the first UE and the second UE, which is not limited in the disclosure.

Specifically, for the MCCH, it may be distinguished by the MCCH-RNTI. For example, an MCCH-RNTI #1 is configured for the first UE, and an MCCH-RNTI #2 is configured for the second UE. Similarly, for the MTCH, it may be distinguished by the G-RNTI. For example, a G-RNTI #1 is configured for the first UE, and a G-RNTI #2 is configured for the second UE.

In some optional embodiments, for the MCCH transmission, the same value of the transmission parameter may be configured for the first UE and the second UE, while for the MTCH, separate and different values of the transmission parameter may be configured for the first UE and the second UE, respectively. In other words, different configuration rules may be used for the MCCH and the MTCH, and vice versa, which will not be repeated here.

In some optional embodiments, channels may not be distinguished, and a common configuration parameter value may be used for the two types of the terminal, which is not limited in the disclosure. In some embodiments, in a case where configuring the separate transmission parameter for the terminal, the network device may, for the MTCH transmission, send a fourth configuration signaling to the first UE, and send a fifth configuration signaling to the second UE, respectively. For the MCCH transmission, the network device may send a sixth configuration signaling to the first UE, and send a seventh configuration signaling to the second UE, respectively. The fourth configuration signaling indicates a fourth transmission parameter, the fifth configuration signaling indicates a fifth transmission parameter, the sixth configuration signaling indicates a sixth transmission parameter, the seventh configuration signaling indicates a seventh transmission parameter. Values of transmission parameters indicated by at least two of the fourth configuration signaling, the fifth configuration signaling, the sixth configuration signaling, and the seventh configuration signaling are different.

In other words, in a case where different types of terminals use the different parameters, the network device may also configure the transmission parameters according to different transmission modes, such as the MTCH transmission and the MCCH transmission. That is, different transmission parameter configurations may be performed for different transmission modes. For example, the MTCH transmission uses the transmission parameter(s) configured by the network device for the MTCH transmission, and the MCCH transmission uses the transmission parameter(s) configured by the network device for the MCCH transmission.

For example, the network device may send the fourth configuration signaling to the first UE in the MCCH transmission to configure the fourth transmission parameter, such as configuring the initial BWP, the CFR, or other parameters. The network device may send the fifth configuration signaling to the second UE in the MCCH transmission to configure the fifth transmission parameter, such as configuring the offset of the MCCH window, the period of the MCCH window or other parameters. In this case, the fifth transmission parameter may be different from the fourth transmission parameter, that is, different types of terminals use separate transmission parameters, respectively. Moreover, the network device may further send the sixth configuration signaling to the first UE in the MTCH transmission to configure the sixth transmission parameter, such as configuring the CORESET, the search space or other parameters. The network device may send the seventh configuration signaling to the second UE in the MTCH transmission to configure the seventh transmission parameter, such as configuring the initial BWP, the CFR, or other parameters. In this case, the sixth transmission parameter may be different from the seventh transmission parameter, that is, different types of terminals use separate transmission parameters, respectively. For example, the network device configures a CFR #1 for the first UE, and configures a CFR #2 for the second UE. In other words, the network device configures a value of a separate transmission parameter for the first UE (i.e., the eRedCap UE).

In embodiments, the network device configures the separate transmission parameters for the first UE and the second UE respectively, such that the network device allocates reasonable frequency domain resources for the broadcast transmission of different types of terminals, thereby ensuring the transmission effectiveness and avoiding reducing the energy consumption of the terminal.

Referring to FIG. 5, FIG. 5 is a schematic flow chart illustrating a communication control method according to an embodiment. The method is performed by a UE. As shown in FIG. 5, the method may include but is not limited to a following step.

In step S501, a transmission parameter is determined according to a configuration signaling of a network device.

In some optional implementations, the UE may determine the transmission parameter according to the configuration signaling of the network device, in which the transmission parameter is a parameter corresponding to an MTCH transmission and/or an MCCH transmission.

Specifically, in a case where the network device configures the transmission parameter, the transmission parameter may include but is not limited to at least one of: an initial BWP; a CFR; a CORESET; a search space; an offset of an MCCH window; a period of an MCCH window; a G-RNTI; an MCCH-RNTI; or a DMRS resource.

In some embodiments, for a first UE, a number of PDSCH frequency domain RBs of the MTCH transmission is less than or equal to a first threshold, and/or a number of PDSCH frequency domain RBs of the MCCH transmission is less than or equal to the first threshold. The first threshold may be different values according to different SCS. For example, in a case where the SCS is 30 kHz, the number of RBs of the PDSCH of the terminal does not exceed 12 RBs, that is, the first threshold may be 12. In a case where the SCS is 15 kHZ, the number of RBs of the PDSCH of the terminal does not exceed 25 RBs, that is, the first threshold may be 25.

In some embodiments, the UE includes a first UE and/or a second UE, the first UE may be an eRedcap UE, and the second UE may be a non-eRedcap UE. The disclosure does not impose special restrictions on the specific model of the UE.

In some embodiments, the first UE may include one or more eRedcap UEs, and the second UE may include one or more non-eRedcap UEs, which is not limited in the disclosure.

In embodiments, as described in step S201, the network device may adopt different configuration methods in a case of configuring the transmission parameter. That is, the network device may perform the transmission parameter configuration for different types of terminals according to different methods. The network device may perform the configuration according to parameter categories, such as according to whether the transmission parameters are shared among devices. The network device may further perform the configuration according to different transmission categories, such as configuring separately for the MTCH transmission and the MCCH transmission. Accordingly, for different configuration methods, the UE may perform corresponding determination. Examples are given below.

a) The network device configures a shared transmission parameter for different types of terminals.

Configuring the shared transmission parameter refers to configuring a same value of the transmission parameter for the first UE and the second UE.

In this embodiment, the UE includes the first UE and the second UE, and a first transmission parameter configured by the network device to the first UE and the second UE may be determined correspondingly, in which the first UE and the second UE share the first transmission parameter.

In some embodiments, in a case where the different types of terminals share and use the same parameter, the network device may further configure the transmission parameters according to different transmission methods, such as the MTCH transmission and the MCCH transmission. Accordingly, the UE may also determine the transmission parameters according to different transmission methods.

b) The network device configures separate transmission parameters for different types of terminals.

Configuring the separate transmission parameters refers to configuring different values of the transmission parameters for the first UE and the second UE. The first UE and the second UE may be respectively configured with at least one type of transmission parameter with different values. In other words, the transmission parameters with the same type but different values may be configured.

In this embodiment, the UE includes the first UE and the second UE, and a second transmission parameter configured by the network device to the first UE and a third transmission parameter configured by the network device to the second UE may be correspondingly determined, in which a value of the second transmission parameter is different from a value of the third transmission parameter.

In some embodiments, in a case where the different types of terminals share and use the different parameters, the network device may further configure the transmission parameters according to different transmission methods, such as the MTCH transmission and the MCCH transmission. Accordingly, the UE may also determine the transmission parameters according to different transmission methods.

In embodiments, the network device may determine the transmission parameter according to the configuration signaling of the network device, that is, the UE may determine the transmission parameter(s) configured by the network device to the first UE and the second UE. Thus, by using the configured transmission parameter(s), the network device may allocate reasonable frequency domain resources for the broadcast transmission of different types of terminals, thereby ensuring the transmission effectiveness and improving the communication capability.

Referring to FIG. 6, FIG. 6 is a schematic flow chart illustrating a communication control method according to an embodiment. The method is performed by a UE. The embodiment shown in FIG. 6 is a further explanation of step S501 in the embodiments of FIG. 5. The method may include but is not limited to a following step.

In S601, a first transmission parameter configured by a network device to a first UE and a second UE is determined.

In this embodiment, the UE may determine the first transmission parameter configured by the network device to the first UE and the second UE, in which the first UE and the second UE share the first transmission parameter. That is, the network device configures a same transmission parameter to the first UE and the second UE, and the first UE and the second UE share the same transmission parameter.

In some embodiments, in a case where configuring a shared transmission parameter for the terminal, the UE may also determine a fourth transmission parameter configured by the network device to the first UE and a fifth transmission parameter configured by the network device to the second UE respectively, in which the fourth transmission parameter and the fifth transmission parameter are configured by the network device for an MTCH transmission. The UE may also determine a sixth transmission parameter configured by the network device to the first UE and a seventh transmission parameter configured by the network device to the second UE respectively, in which the sixth transmission parameter and the seventh transmission parameter are configured by the network device for an MCCH transmission. Values of at least two of the fourth transmission parameter, the fifth transmission parameter, the sixth transmission parameter, and the seventh transmission parameter are different.

In other words, in a case where different types of terminals share and use a same parameter, the UE may determine the transmission parameters configured by the network device according to different transmission methods, such as the MTCH transmission and the MCCH transmission. For example, the UE may determine the transmission parameter configured by the network device for the MTCH transmission, and the UE may also determine the transmission parameter configured by the network device for the MCCH transmission.

In embodiments, the UE may determine the shared transmission parameter configured by the network device to the first UE and the second UE, such that the network device allocates reasonable frequency domain resources for the broadcast transmission of different types of terminals, thereby ensuring the transmission effectiveness and avoiding reducing the energy consumption of the terminal.

Referring to FIG. 7, FIG. 7 is a schematic flow chart illustrating a communication control method according to an embodiment. The method is performed by a UE. The embodiment shown in FIG. 7 is a further explanation of step S501 in the embodiments of FIG. 5. The method may include but is not limited to a following step.

In S701, a second transmission parameter configured by a network device to a first UE is determined and a third transmission parameter configured by the network device to a second UE is determined.

In this embodiment, the UE may determine the second transmission parameter configured by the network device to the first UE, and may determine the third transmission parameter configured by the network device to the second UE, in which a value of the second transmission parameter is different from a value of the third transmission parameter. That is, the network device configures separate transmission parameters to the first UE and the second UE respectively, and the first UE and the second UE do not share the same transmission parameter.

In some embodiments, in a case where configuring a separate transmission parameter for the terminal, the UE may further determine a fourth transmission parameter configured by the network device for an MTCH transmission to the first UE and a fifth transmission parameter configured by the network device for the MTCH transmission to the second UE respectively. In some embodiments, the UE may determine a sixth transmission parameter configured by the network device for an MCCH transmission to the first UE and a seventh transmission parameter configured by the network device for the MCCH transmission to the second UE respectively. Values of at least two of the fourth transmission parameter, the fifth transmission parameter, the sixth transmission parameter, and the seventh transmission parameter are different.

In other words, in a case where different types of terminals share and use the transmission parameter, the UE may determine the transmission parameters configured by the network device according to different transmission methods, such as the MTCH transmission and the MCCH transmission. For example, the UE may determine the transmission parameter configured by the network device for the MTCH transmission, and the UE may further determine the transmission parameter configured by the network device for the MCCH transmission.

In embodiments, the UE may determine the separate transmission parameters configured by the network device to the first UE and the second UE, such that the network device allocates reasonable frequency domain resources for the broadcast transmission of different types of terminals, thereby ensuring the transmission effectiveness and avoiding reducing the energy consumption of the terminal.

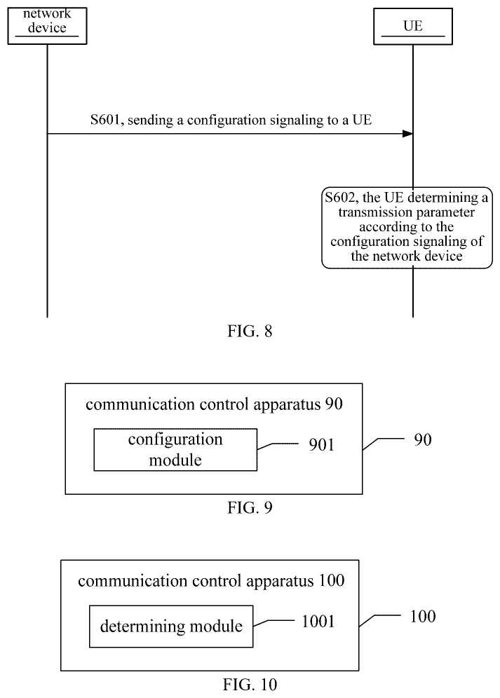

FIG. 8 is an interactive schematic diagram illustrating a communication control method according to an embodiment. The method is performed by a communication system. The communication system includes a network device and a UE. The method includes the following steps.

In step S801, a configuration signaling is sent to the UE.

In step S802, the UE determines a transmission parameter according to the configuration signaling of the network device.

The detailed explanation of the above steps S801 and S802 may refer to the embodiments described in FIG. 2 to FIG. 7, which will not be described in detail here.

Referring to FIG. 9, FIG. 9 is a schematic block diagram illustrating a communication control apparatus 90 according to an embodiment. The communication control apparatus 90 shown in FIG. 9 is performed by a network device and may include a configuration module 901 configured to send a configuration signaling to a UE. The configuration signaling indicates a transmission parameter, and the transmission parameter is a parameter corresponding to an MTCH transmission and/or an MCCH transmission.

In some embodiments, the UE includes a first UE and/or a second UE, the first UE is an eRedcap UE, and the second UE is a non-eRedcap UE.

In some embodiments, for the first UE, a number of PDSCH frequency domain RBs of the MTCH transmission is less than or equal to a first threshold, and/or a number of PDSCH frequency domain RBs of the MCCH transmission is less than or equal to the first threshold.

In some embodiments, the transmission parameter includes at least one of: an initial BWP; a CFR; a CORESET; a search space; an offset of an MCCH window; a period of an MCCH window; a G-RNTI; an MCCH-RNTI; or a DMRS resource.

In some embodiments, in a case of sending the configuration signaling to the UE, the configuration module 901 is further configured to send a first configuration signaling to the first UE and the second UE, in which the first configuration signaling indicates a first transmission parameter, and the first UE and the second UE share a value of the first transmission parameter; or send a second configuration signaling to the first UE, and sending a third configuration signaling to the second UE, in which the second configuration signaling indicates a second transmission parameter, the third configuration signaling indicates a third transmission parameter, and a value of the second transmission parameter is different from a value of the third transmission parameter.

In some embodiments, in a case of sending the configuration signaling to the UE, the configuration module 901 is further configured to, for the MTCH transmission, send a fourth configuration signaling to the first UE, and a fifth configuration signaling to the second UE respectively; and for the MCCH transmission, send a sixth configuration signaling to the first UE and a seventh configuration signaling to the second UE respectively, in which the fourth configuration signaling indicates a fourth transmission parameter, the fifth configuration signaling indicates a fifth transmission parameter, the sixth configuration signaling indicates a sixth transmission parameter, the seventh configuration signaling indicates a seventh transmission parameter, and values of transmission parameters indicated by at least two of the fourth configuration signaling, the fifth configuration signaling, the sixth configuration signaling, and the seventh configuration signaling are different.

In some embodiments, the configuration module 901 is configured to determine a type of the transmission parameter.

Referring to FIG. 10, FIG. 10 is a schematic block diagram illustrating a communication control apparatus 100 according to an embodiment. The communication control apparatus 100 shown in FIG. 10 is performed by a UE and may include:
a determining module 1001 configured to determine a transmission parameter according to a configuration signaling of a network device, in which the transmission parameter is a parameter corresponding to an MTCH transmission and/or an MCCH transmission.

In some embodiments, the UE includes a first UE and/or a second UE, the first UE is an eRedcap UE, and the second UE is a non-eRedcap UE.

In some embodiments, for the first UE, a number of PDSCH frequency domain RB of the MTCH transmission is less than or equal to a first threshold, and/or a number of PDSCH frequency domain RBs of the MCCH transmission is less than or equal to the first threshold.

In some embodiments, the transmission parameter includes at least one of: an initial BWP; a CFR; a CORESET; a search space; an offset of an MCCH window; a period of an MCCH window; a G-RNTI; an MCCH-RNTI; or a DMRS resource.

In some embodiments, the UE includes a first UE and/or a second UE. In a case of determining the transmission parameter according to the configuration signaling of the network device, the determining module 1001 is further configured to determine a first transmission parameter configured by the network device to the first UE and the second UE, in which the first UE and the second UE share a value of a first transmission parameter; or determine a second transmission parameter configured by the network device to the first UE and a third transmission parameter configured by the network device to the second UE, in which a value of the second transmission parameter is different from a value of the third transmission parameter.

In some embodiments, the UE includes a first UE and/or a second UE. In a case of determining the transmission parameter according to the configuration signaling of the network device, the determining module 1001 is further configured to, for the MTCH transmission, determine a fourth transmission parameter configured by the network device to the first UE and a fifth transmission parameter configured by the network device to the second UE respectively; and for the MCCH transmission, determine a sixth transmission parameter configured by the network device to the first UE and a seventh transmission parameter configured by the network device to the second UE respectively, in which values of at least two of the fourth transmission parameter, the fifth transmission parameter, the sixth transmission parameter, and the seventh transmission parameter are different.

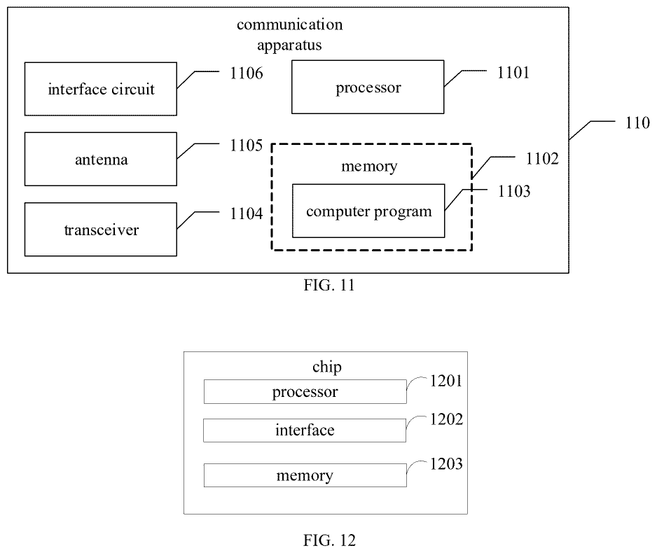

Referring to FIG. 11, FIG. 11 is a schematic block diagram illustrating another communication apparatus 110 according to an embodiment. The communication apparatus 110 may be a network device; a terminal; a chip, a chip system or a processor supporting the network device to implement the above-mentioned method; or a chip, a chip system or a processor supporting the terminal to implement the above-mentioned method. The communication apparatus 110 may be configured to implement the method as described in above method embodiments, with particular reference to the description of method embodiments described above.

The communication apparatus 110 may include one or more processors 1101. The processor 1101 may be a general-purpose processor or a special-purpose processor, etc. It may be, for example, a baseband processor or a central processor. The baseband processor may be configured to process a communication protocol and communication data, and the central processor may be configured to control a communication apparatus (such as a base station, a baseband chip, a terminal, a terminal chip, a DU, or a CU, etc.), execute a computer program and process data of the computer program.

In some embodiments, the communication apparatus 110 may further include one or more memories 1102 on which the computer program 1103 may be stored, and the processor 1101 executes the computer program 1103 to cause the communication apparatus 110 to perform the method as described in above method embodiments. In some embodiments, the memory 1102 may also have the data stored therein. The communication apparatus 110 and the memory 1102 may be provided independently or integrated together.

In some embodiments, the communication apparatus 110 may further include a transceiver 1104 and an antenna 1105. The transceiver 1104 may be referred to as a transceiver unit, a transceiver machine, or a transceiver circuit for implementing a transceiving function. The transceiver 1104 may include a receiver and a transmitter, the receiver may be referred to as a receiving machine or a receiving circuit or the like for implementing a receiving function; and the transmitter may be referred to as a transmitting machine or a transmission circuit or the like for implementing a transmitting function.

In some embodiments, the communication apparatus 110 may further include one or more interface circuits 1106. The interface circuit 1106 is configured to receive code instructions and transmit the code instructions to the processor 1101. The processor 1101 executes the code instructions to cause the communication apparatus 110 to perform the method described in above method embodiments.

The communication apparatus 110 is a terminal device configured to implement the functions of the terminal device in the aforementioned embodiments.

The communication apparatus 110 is a network device configured to implement the functions of the network device in the aforementioned embodiments.

In an implementation, the processor 1101 may further include the transceiver for implementing receiving and transmitting functions. For example, the transceiver may be a transceiver circuit, or an interface, or an interface circuit. The transceiver circuit, interface, or interface circuit for implementing the receiving and transmitting functions may be separated or integrated. The transceiver circuit, interface or interface circuit may be configured to read and write code/data, or the transceiver circuit, interface or interface circuit may be configured for transmission or transfer of signals.

In an implementation, the processor 1101 may have stored therein the computer program 1103 that, when run on the processor 1101, causes the communication apparatus 110 to perform the method described in above method embodiments. The computer program 1103 may be solidified in the processor 1101, in which case the processor 1101 may be implemented in hardware.

In an implementation, the communication apparatus 110 may include a circuit that may implement a transmitting, receiving, or communicating function in foregoing method embodiments. The processor and transceiver described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies such as complementary metal oxide semiconductor (CMOS), n-metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus in above embodiments may be the network device or the terminal, but the scope of the communication apparatus described in the disclosure is not limited thereto. Moreover, the structure of the communication apparatus may not be limited by FIG. 11. The communication apparatus may be a stand-alone device or may be a part of a larger device. For example, the communication apparatus may be:
(1) a stand-alone integrated circuit (IC), or a chip, or a chip system or a subsystem;
(2) a set of one or more ICs, In some embodiments the set of ICs may also include a storage component for storing the data and the computer program;
(3) ASIC, such as modem;
(4) a module that may be embedded in other devices;
(5) a receiver, a terminal, an intelligent terminal, a cellular phone, a wireless device, a handset, a mobile unit, an on-vehicle device, a network device, a cloud device, an artificial intelligence device, etc. ; or
(6) others.

In a case where the communication apparatus may be the chip or the chip system, reference may be made to the schematic block diagram of the chip shown in FIG. 12. The chip shown in FIG. 12 includes a processor 1201 and an interface 1202. There may be one or more processors 1201 and a plurality of interfaces 1202.

The disclosure further provides a chip, and reference may be made to the schematic block diagram of the chip shown in FIG. 12. The chip shown in FIG. 12 includes a processor 1201 and an interface 1202. There may be one or more processors 1201 and a plurality of interfaces 1202. In some embodiments, the chip also includes a memory 1203, which is configured to store computer instructions. In a case where the processor executes the computer instructions, the electronic device executes the communication control method described in the above embodiment.

Those skilled in the art may also understand that various illustrative logical blocks and steps listed in the embodiments may be implemented by electronic hardware, computer software, or a combination thereof. Whether such functions are implemented by hardware or software depends on specific applications and design requirements of an overall system. For each specific application, those skilled in the art may use various methods to implement the function, but such an implementation should not be understood as extending beyond the protection scope of embodiments.

Embodiments further provides a communication system, which includes the communication apparatus as a terminal and the communication apparatus as a network device in the aforementioned embodiments of FIG. 1 to FIG. 10, or includes the communication apparatus as a terminal and the communication apparatus as a network device in the aforementioned embodiments of FIG. 11.

The disclosure further provides a readable storage medium having instructions stored thereon that, when executed by a computer, causes the functions of any of the method embodiments described above to be implemented.

The disclosure also provides a computer program product that, when executed by a computer, causes the functions of any of the method embodiments described above to be implemented.

The above embodiments may be implemented in whole or in part by software, hardware, firmware, or any combination thereof. When implemented using the software, the above embodiments may be implemented in whole or in part in a form of the computer program product. The computer program product includes one or more computer programs. When the computer programs are loaded and executed on the computer, all or part of the processes or functions according to an embodiment will be generated. The computer may be a general purpose computer, a special purpose computer, a computer network, or other programmable devices. The computer programs may be stored in a computer-readable storage medium or transmitted from one computer-readable storage medium to another computer-readable storage medium. For example, the computer programs may be transmitted from one website site, computer, server or data center to another website site, computer, server, or data center in a wired manner (such as via a coaxial cable, an optical fiber, a digital subscriber line (DSL)) or a wireless manner (such as via infrared, wireless, or microwave, etc.). The computer-readable storage medium may be any available medium that may be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)), etc.

Those of ordinary skill in the art can understand that the first, second, and other numeral numbers involved in the disclosure are for convenience of description, and are not intended to limit the scope of embodiments, nor are they intended to represent a sequential order.

The term “at least one” used in the disclosure may also be described as one or more, and the term “a plurality of” may cover two, three, four or more, which are not limited in the disclosure. In embodiments, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority and have no order of size.

The correspondence shown in each table in the disclosure may be configured or predefined. The values of various information in each table are examples, and may be configured as other values, which are not limited in the disclosure. When configuring a correspondence between the information and various parameters, it is not necessary to configure all the correspondences shown in the tables. For example, the correspondences shown in some rows of a table in the disclosure may not be configured. For another example, appropriate deformations or adjustments (such as splitting, merging, and so on) may be made based on the above table. The names of parameters shown in the titles of the above tables may adopt other names understandable by the communication apparatus, and the values or representations of the parameters may also be other values or representations understandable by the communication apparatus. When the above tables are implemented, other data structures may also be used, for example, arrays, queues, containers, stacks, linear tables, pointers, linked lists, trees, graphs, structural body, classes, heaps, or hash tables may be used.

The term “predefinition” in the disclosure may be understood as definition, predefinition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the disclosure.

Those skilled in the art can clearly understand that for the convenience and brevity of the description, the specific working process of the above-described system, device and unit may refer to the corresponding process in the foregoing method embodiments, which will not be repeated here.

The above has described some specific embodiments, but the scope of the disclosure is not limited thereto. Any person skilled in the art may easily think of changes or substitutions within the technical scope of the disclosure, which shall be covered by the protection scope of the disclosure. Therefore, the protection scope of the disclosure shall be in line with the attached claims.

1. A communication control method, performed by a network device, comprising:
sending a configuration signaling to a user equipment (UE),
wherein the configuration signaling indicates a transmission parameter, and the transmission parameter is a parameter corresponding to at least one of a multicast traffic channel (MTCH) transmission or a multicast control channel (MCCH) transmission.

2. The communication control method of claim 1, wherein the UE comprises at least one of a first UE or a second UE, the first UE is an enhanced capability reduction (eRedcap) UE, and the second UE is a non-enhanced capability reduction (non-eRedcap) UE.

3. The communication control method of claim 2, wherein for the first UE, at least one of a number of physical downlink shared channel (PDSCH) frequency domain resource blocks (RBs) of the MTCH transmission or a number of PDSCH frequency domain RBs of the MCCH transmission is less than or equal to a first threshold.

4. The communication control method of claim 1, wherein the transmission parameter comprises at least one of:
an initial bandwidth part (BWP);
a common frequency resource (CFR);
a control resource set (CORESET);
a search space;
an offset of an MCCH window;
a period of an MCCH window;
a group radio network temporary identifier (G-RNTI);
an MCCH-RNTI; or
a demodulation reference signal (DMRS) resource.

5. The communication control method of claim 3, wherein sending the configuration signaling to the UE comprises:
sending a first configuration signaling to the first UE and the second UE, wherein the first configuration signaling indicates a first transmission parameter, and the first UE and the second UE share a value of the first transmission parameter; or
sending a second configuration signaling to the first UE, and sending a third configuration signaling to the second UE, wherein the second configuration signaling indicates a second transmission parameter, the third configuration signaling indicates a third transmission parameter, and a value of the second transmission parameter is different from a value of the third transmission parameter.

6. The communication control method of claim 1, wherein the UE comprises at least one of a first UE or a second UE, wherein sending the configuration signaling to the UE comprises:
for the MTCH transmission, sending a fourth configuration signaling to the first UE and a fifth configuration signaling to the second UE respectively; and
for the MCCH transmission, sending a sixth configuration signaling to the first UE and a seventh configuration signaling to the second UE respectively,
wherein the fourth configuration signaling indicates a fourth transmission parameter, the fifth configuration signaling indicates a fifth transmission parameter, the sixth configuration signaling indicates a sixth transmission parameter, the seventh configuration signaling indicates a seventh transmission parameter, and values of transmission parameters indicated by at least two of the fourth configuration signaling, the fifth configuration signaling, the sixth configuration signaling, and the seventh configuration signaling are different.

7. The communication control method of claim 1, further comprising:
determining a type of the transmission parameter.

8. A communication control method, performed by a user equipment (UE), comprising:
determining a transmission parameter according to a configuration signaling of a network device,
wherein the transmission parameter is a parameter corresponding to at least one of a multicast traffic channel (MTCH) transmission or a multicast control channel (MCCH) transmission.

9. The communication control method of claim 8, wherein the UE comprises at least one of a first UE or a second UE, the first UE is an enhanced capability reduction (eRedcap) UE, and the second UE is a non-enhanced capability reduction (non-eRedcap) UE.

10. The communication control method of claim 9, wherein for the first UE, at least one of a number of physical downlink shared channel (PDSCH) frequency domain resource blocks (RB) of the MTCH transmission or a number of PDSCH frequency domain RBs of the MCCH transmission is less than or equal to a first threshold.

11. The communication control method of claim 8, wherein the transmission parameter comprises at least one of:
an initial bandwidth part (BWP);
a common frequency resource (CFR);
a control resource set (CORESET);
a search space;
an offset of an MCCH window;
a period of an MCCH window;
a group radio network temporary identifier (G-RNTI);
an MCCH-RNTI; or
a demodulation reference signal (DMRS) resource.

12. The communication control method of claim 8, wherein the UE comprises at least one of a first UE or a second UE, and determining the transmission parameter according to the configuration signaling of the network device comprises:
determining a first transmission parameter configured by the network device to the first UE and the second UE, wherein the first UE and the second UE share a value of a first transmission parameter; or
determining a second transmission parameter configured by the network device to the first UE and a third transmission parameter configured by the network device to the second UE, wherein a value of the second transmission parameter is different from a value of the third transmission parameter.

13. The communication control method of claim 8, wherein the UE comprises at least one of a first UE or a second UE, and determining the transmission parameter according to the configuration signaling of the network device comprises:
for the MTCH transmission, determining a fourth transmission parameter configured by the network device to the first UE and a fifth transmission parameter configured by the network device to the second UE respectively; and
for the MCCH transmission, determining a sixth transmission parameter configured by the network device to the first UE and a seventh transmission parameter configured by the network device to the second UE respectively,
wherein values of at least two of the fourth transmission parameter, the fifth transmission parameter, the sixth transmission parameter, and the seventh transmission parameter are different.

14.-15. (canceled)

16. A communication apparatus, comprising:
a transceiver;
a memory; and
a processor connected to the transceiver and the memory respectively, configured to
send a configuration signaling to a user equipment (UE),
wherein the configuration signaling indicates a transmission parameter, and the transmission parameter is a parameter corresponding to at least one of a multicast traffic channel (MTCH) transmission or a multicast control channel (MCCH) transmission.

17. A non-transitory computer storage medium having stored therein computer-executable instructions that, when executed by a processor, cause the method of claim 8, to be implemented.

18. (canceled)

19. The communication apparatus of claim 16, wherein the UE comprises at least one of a first UE or a second UE, the first UE is an enhanced capability reduction (eRedcap) UE, and the second UE is a non-enhanced capability reduction (non-eRedcap) UE.

20. The communication apparatus of claim 19, wherein for the first UE, at least one of a number of physical downlink shared channel (PDSCH) frequency domain resource blocks (RBs) of the MTCH transmission or a number of PDSCH frequency domain RBs of the MCCH transmission is less than or equal to a first threshold.

21. The communication apparatus of claim 16, wherein the transmission parameter comprises at least one of:
an initial bandwidth part (BWP);
a common frequency resource (CFR);
a control resource set (CORESET);
a search space;
an offset of an MCCH window;
a period of an MCCH window;
a group radio network temporary identifier (G-RNTI);
an MCCH-RNTI; or
a demodulation reference signal (DMRS) resource.

22. A communication apparatus, comprising:
a transceiver;
a memory; and
a processor connected to the transceiver and the memory respectively, configured to perform the method of claim 8.

23. A non-transitory computer storage medium having stored therein computer-executable instructions that, when executed by a processor, cause the method of claim 8 to be implemented.
